(19) United States
(12) Patent Application Publication
(10) Pub. No.: US 2007/0182297 A1
(43) Pub. Date: Aug. 9, 2007

(54) Electroluminescent panel provided with light extraction elements

(76) Inventors: Valter Drazic, Betton (FR); Christophe Fery, Rennes (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/567,258

(22) PCT Filed: Aug. 12, 2004
(86) PCT No.: PCT/EP04/09039

§ 371 Date: Jul. 14, 2006

(30) Foreign Application Priority Data
Aug. 14, 2003 (FR) 03/09970

(51) Int. Cl. H01J 5/16

(52) U.S. Cl. 313/110; 313/504

(57) ABSTRACT

Display comprising a substrate 1 carrying:
an electroluminescent organic layer partitioned into electroluminescent cells 21 and inserted between two electrode layers of which one is transparent and the other opaque,
a layer 3 of light extractors operating by reflection, each extractor 31 being made of transparent material and comprising an entry interface 32, an exit interface 33 and reflecting side walls 34,
where the electroluminescent layer region of each cell 21 is optically coupled to a plurality of extractors 31. The light extraction efficiencies are improved while limiting the constraints on manufacturing and keeping the display thickness limited.

The invention relates to a lighting or image display panel comprising a one- or two-dimensional matrix of electroluminescent organic cells (“OLED”) having means for facilitating the extraction of the light emitted by the cells, which significantly improve the luminous efficiency.

Such a display panel generally comprises a substrate carrying an electroluminescent organic thin layer partitioned into electroluminescent cells and inserted between at least two arrays of electrodes, one of anodes and the other of cathodes, for supplying power to each of the cells. Such a display panel also comprises an encapsulation layer, applied to one of the electrode layers on the opposite side to the substrate, which is designed to hermetically seal the cells so as to protect the electroluminescent layer against any risk of damage, notably from the effects of oxygen or water vapour in the atmosphere.

This substrate is generally made of glass, but may be made of plastic; the substrate thickness is, in general, in the range between 300 and 1500 μm which is 100 to 500 times thicker than the electroluminescent organic layer; the length of the side or diameter of the cells (pixels or subpixels) is generally in the range between 100 and 300 μm, or between 1 and 15 times thinner than the substrate.

The layer of electrodes inserted between the substrate and the electroluminescent layer, which may comprise several electrode arrays, is generally referred to as the “bottom layer” since, in conventional fabrication processes, it is applied before the electroluminescent layer; the other electrode layer, applied after and “above” the electroluminescent layer, is referred to as the “top layer”.

Depending on the configuration, the light emitted by the electroluminescent layer must pass through the substrate and hence the bottom layer of electrodes in order to reach the observer of the images to be displayed (the case of what are called “back-emitting” displays), or on the contrary pass through the top electrode layer (without therefore passing through the substrate—the case of what are called “top-emitting” displays); in both cases, the light emitted by the electroluminescent layer must pass through one of the electrode layers, the other electrode layer generally being opaque.

The transparent electrode layer is generally made from “ITO” and, given the electronic properties of ITO, generally serves as the cell anode; the other electrode layer being opaque is generally metallic and then serves as the cell cathode; this latter layer can be reflective in order to recover the light emitted in the opposite direction to the observer.

Each cell of the display therefore emits light towards the outside through a “window” comprising a transparent electrode layer region, and, as the case may be, a transparent substrate region.

The various emission or transparent layers generally exhibit high refractive indices: 1.6 to 1.7 for the electroluminescent layer, 1.6 to 2 for the ITO electrode layer, and, where the light emitted passes through the substrate, about 1.5 for a glass substrate; the large difference in refractive index between these layers and air (index=1), where the observer is located, considerably limits the extraction efficiency of the light emitted by the electroluminescent layer, which in turn limits the luminous efficiency of the display; indeed, any light ray arriving at one of the optical interfaces between these layers (or between the last layer and the air) with an angle of incidence greater than the critical angle of refraction at this interface (or total internal reflection angle) will be totally reflected and trapped within the display panel and generally lost. Without the additional extraction system such as that described below, the extraction efficiency is generally about 0.19 in the favourable case where the opaque electrode layer is reflective.

In order to improve the extraction of light, the documents U.S. Pat. No. 6,091,384—PIONEER—and U.S. Pat. No. 6,229,160—LUMILEDS LIGHTING—propose systems for extraction by reflection: a transparent light extraction bar is abutted to the emission window of each cell; other documents propose systems for extraction by refraction based on lenses (with one lens per cell), or micro-lenses (with a plurality of lenses per cell) such as JP 2001-117 499.

According to the aforementioned documents relating to the light extraction bars, each of these extraction bars is made from transparent material and forms a light channel that comprises a transparent entry interface abutted to the emission window of a cell, a transparent exit interface directed towards the outside of the display and, in between these interfaces, reflecting side walls.

The refractive index of the bar material is chosen such that the major part of the light emitted within the electroluminescent layer penetrates into these bars; each bar therefore forms a light extraction channel for its corresponding cell.

The shape of the entry interface of these bars is matched to the shape of the cell emission windows.

The shape of the exit interface of these bars, the length of these bars and the shape of their side walls are chosen such that the major part of the light entering the entry interface of a bar emerges from its exit interface, either directly or after internal reflection on the side walls of this bar.

The side walls of these bars can be opaque and reflecting or transparent; reflecting opaque walls are obtained, for example, by metallization; when they are transparent, it is important that the optical interface formed by these walls offers as high a critical angle of refraction as possible in order to reflect the major part of the rays that strike it and allow the extraction of the rays from the exit interface.

The role of the side walls of each bar is to modify, by reflection, the direction of the light rays striking them so as to reduce the angle of incidence of these rays on the exit interface of this bar to a value below the critical angle of refraction through this exit interface.

In practice, the light extraction bars are generally abutted to each other and form an extraction layer that is applied to the substrate, on the opposite side from the electroluminescent layer, in the case of back-emitting displays, or that is applied to the top layer of transparent electrodes in the case of top-emitting displays.

The thickness of the extraction layer depends on the surface area of the emission window of each cell; it is generally greater than that of the substrate; this layer is therefore relatively thick which makes the display heavy; such a layer cannot be envisaged for flexible panel displays.

There are problems of alignment during the application of such a layer: indeed, it should be positioned such that the entry interface of each bar coincides with the emission window of a cell. These positioning constraints render the display manufacturing process more difficult.

One aim of the invention is to avoid the aforementioned drawbacks.

For this purpose, the subject of the invention is a lighting or image display panel comprising a substrate carrying:
an electroluminescent organic layer partitioned into electroluminescent cells and inserted between two electrode layers of which one is transparent and the other opaque,
a layer of light extractors operating by reflection, each extractor being made from transparent material and comprising a light entry interface optically coupled to the electroluminescent layer, a light exit interface directed towards the outside of the display panel, and side walls forming reflecting optical interfaces for the light propagating within the extractor,

characterized in that the said side walls of each extractor form a closed reflecting surface and in that the electroluminescent layer region of each cell is optically coupled to a plurality of extractors.

In such a display panel, each cell corresponds to a region covering one electrode of each layer. Each cell is capable of emitting light towards the outside of the display through an emission window which comprises, upstream of the layer of extractors, a transparent region of the transparent layer of electrodes and, as the case may be, a transparent region of the substrate; it is via these overlaid transparent regions that the optical coupling of the electroluminescent layer to the plurality of extractors is effected.

According to the invention, the emission window of each cell thus comprises a plurality of extractors such that the light emitted by this cell is. distributed to this plurality of extractors via their entry interface before emerging from the display via their exit interfaces. Thanks to this distribution of the light of each cell over several extractors according to the invention, the extraction layer thickness can be significantly reduced without reducing the extraction performance of this layer. The optical coupling of the entry interface of the extractors to the electroluminescent layer therefore takes place via the transparent electrode layer, and not via the dielectric layer as in the document U.S. Pat. No. 6,320,633.

The region covered by an electrode from each layer may be partitioned, as illustrated in FIGS. 3 and 4B, 22 and 23 of the document US 2002/101152, such that a single and same cell or electroluminescent diode comprises several more or less separate emission regions. It should furthermore be noted that, contrary to the invention, the side walls of the extractors associated with a same cell, and notably illustrated in these same FIGS. 3 and 4B, 22 and 23, do not all form closed surfaces (the case of the two upper emission regions in these figures).

Each extractor comprises therefore a bar made of transparent material, whose ends form the light entry and exit interfaces, and whose side walls form a closed reflecting surface, in other words a “light-tight” channel; a closed surface is understood to mean a surface of which any cross section parallel to the entry or exit interface forms a closed curve, such as a square or a circle; these cross sections can be of any shape: a generally square or circular shape for example. The shape of this reflecting surface may notably be conical.

The transparent electrode layer is not necessarily wholly transparent; it can comprise, for example, opaque conducting grids inserted between the emission windows of the cells.

In the case of a back-emitting display, the substrate, which is therefore transparent, is not necessarily wholly transparent; in the case, for example, of an active matrix display, this substrate integrates electronic circuits for driving the cells which are disposed in between the cell emission windows, such as in the document US 2002/101152.

Preferably, the opaque electrode layer is reflecting, which allows a significant part of the light emitted from the electroluminescent layer in the opposite direction to that of the display output to be redirected in the cell emission windows; this allows the luminous efficiency of the display to be improved.

Preferably, the layer of extractors is applied directly onto the transparent electrode layer via, for example, a layer of transparent adhesive which is much thinner than the extractor layer, being typically around 2 to 3 μm in thickness.

According to this disposition of the invention, in no case, therefore, is the substrate situated in between the layer of extractors and the transparent electrode layer; the distance between the electroluminescent emission layer and the entry interfaces of the extractors is therefore very small, preferably less than or equal to 2 μm, which further improves the light extraction in the presence of the layer of reflecting electrodes behind the electroluminescent layer and which allows the luminous efficiency to be further improved.

Preferably, the said plurality of extractors comprises more than a hundred extractors. This high density of extractors provides notably two important advantages:
it allows the thickness of the extraction layer to be greatly reduced and the weight of the display to be reduced in proportion.
it allows the constraints on the alignment of the extractors with the cells to be very significantly reduced when the extraction layer is applied during the manufacture of the display.

If the dimensions of the cell emission windows are 100 μm×300 μm at the entry of the extraction layer and if six extractors are then disposed across the width and eighteen along the length, an array of 108 extractors per cell is obtained. For each cell, each cell emission window therefore passes via at least over a hundred extractors.

Preferably, the extraction layer serves as an encapsulation layer, or is part of the encapsulation layer (in the case where the latter is a “multilayer”); this disposition is particularly advantageous in the case of top-emitting displays.

The invention will be better understood upon reading the following description, presented by way of a non-limiting example, which makes reference to the appended figures, in which:

FIGS. 1, 2 and 4 show various steps in the manufacture of a display panel according to the invention and according to a first embodiment;

FIG. 3 shows a cross-sectional view of the extraction layer used in the manufacture of the display panel shown in FIGS. 1, 2 and 4.

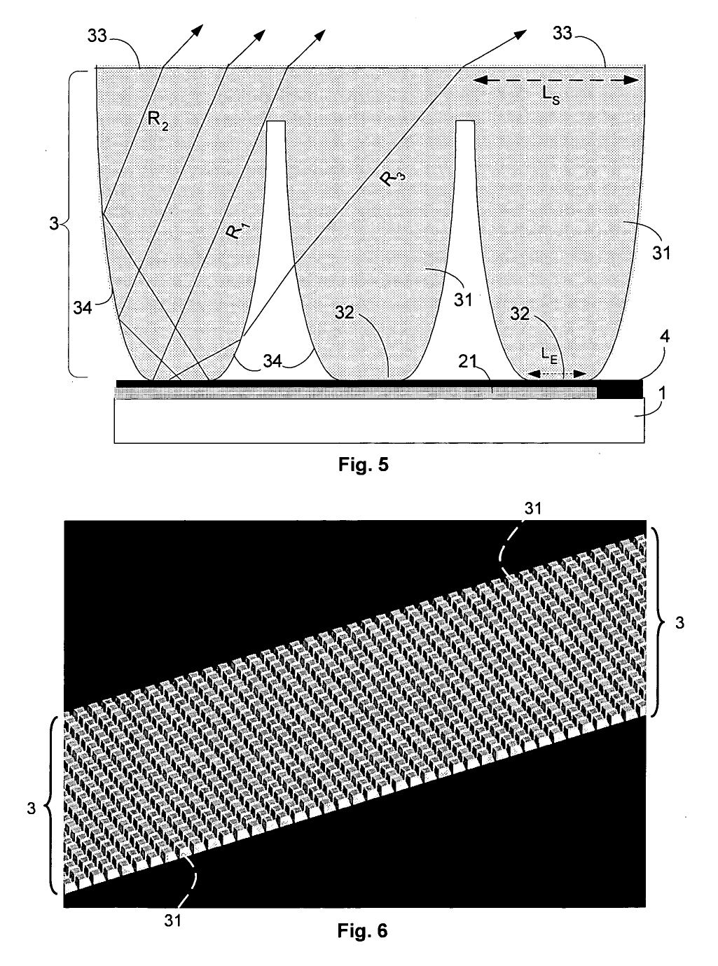

FIG. 5 is a cross-sectional view of three adjacent extractors coupled to the same cell of a display panel according to the invention and according to a second embodiment;

FIG. 6 shows a perspective view from underneath of the extraction layer in FIG. 3.

In order to simplify the description and to make the differences and advantages that the invention presents compared to the techniques of the prior art more apparent, identical references are used for elements that provide the same function.

With reference to FIGS. 1 to 5, a method of manufacture for an electroluminescent image display panel according to the invention, here of the top-emitting type, will firstly be described.

Using conventional methods such as those described in the documents WO 01/15244—EMAGIN and U.S. Pat. No. 5,920,080—FED Co., a layer of metallic electrodes, for example made from aluminium, a partitioned organic electroluminescent layer and a layer of transparent electrodes made from ITO are deposited in succession onto a glass substrate 1, for example 0.75 mm in thickness.

The aluminium layer is reflecting; the electroluminescent layer conventionally comprises several sublayers: apart from the actual electroluminescent emission sublayer itself, it notably comprises an electron injection sublayer in contact with the electrode serving as cathode and a hole injection sublayer in contact with the electrode serving as anode.

The partitions of the organic electroluminescent layer form cells 21 with rectangular bases, for example having dimensions 100 μm×300 μm.

The electroluminescent layer is partitioned into cells 21: power is supplied to each cell between a cathode and an anode belonging to the arrays of electrodes situated on either side of the electroluminescent layer; these electrode arrays are not shown in the figures.

The substrate with its electroluminescent cells is shown in FIG. 1.

In addition, an extraction layer 3 such as that shown in FIG. 6 is prepared; typically, such a layer can be economically produced by hot moulding of a transparent thermoplastic polymer sheet using a mould with a shape designed to form polyhedral shapes in the sheet of extractors 31; each polyhedron here comprises a square light entry interface 32, a square light exit interface 33 and four plane trapezoidal side walls 34.

According to the invention, for the rectangular entry interface 32 of the extractors, much smaller dimensions than those of the cell base are chosen.

For example, the following dimensions may be chosen:
side L_{E} of an entry interface: 3 μm;
side Lₛ of an exit interface: 4 μm;
thickness of extraction layer=height of each extractor: 3 μm;
pitch between adjacent extractors: 5 μm.

The fact that the exit interface has a greater surface area than the entry interface means that each extractor has a flared shape; cylindrical parts (hence not flared) may be abutted to the entry and/or the exit of each extractor.

A cross section of the extraction layer 3 is shown in FIG. 3 together with a magnified view of an extractor 31 having a cylindrical part (with a square cross section) at the entry and/or at the exit.

As is explained below, for the transparent polymer material, a material with a sufficiently high refractive index is chosen in order to improve the optical coupling of the extractors with the electroluminescent layer and so that the side walls of these extractors form essentially reflecting optical interfaces for the light propagating within these extractors. For example, polymer materials such as polyacrylics like PMMA (index=1.49), polycarbonates or polystyrenes (index=1.58-1.59) may be employed.

The construction of the display panel according to the invention is now described below.

A layer of transparent adhesive 4 is applied to the electroluminescent cells of the substrate as shown in FIG. 1; in order to improve the optical coupling between the cells and the extractors, an adhesive having a refractive index between that of the layer of transparent electrodes covering the cells and that of the extraction layer 3 is preferably chosen; the thickness of the adhesive layer is generally in the range 1 to 2 μm.

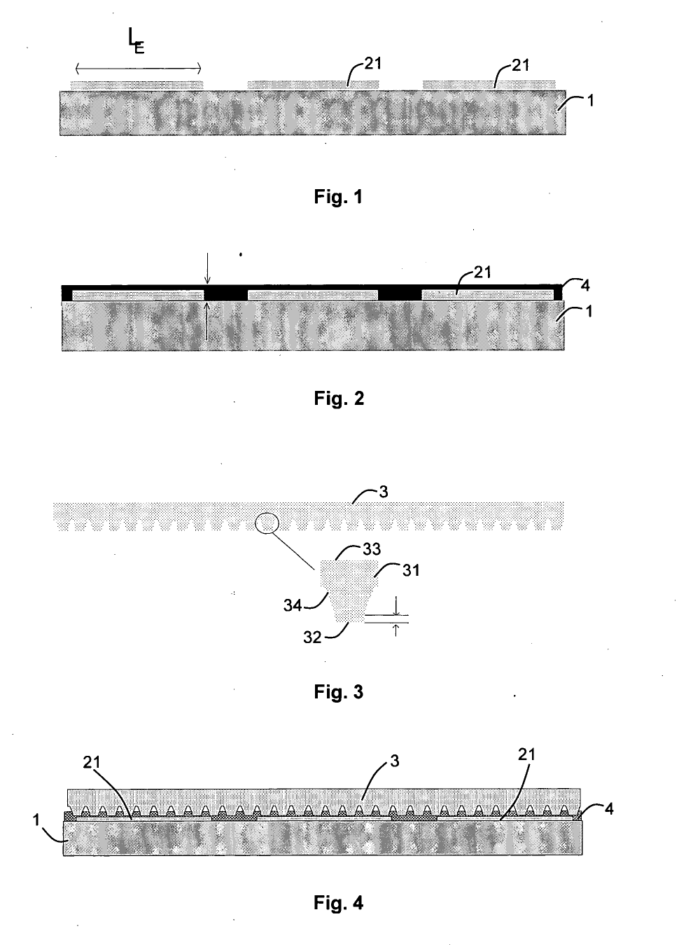

The substrate with its electroluminescent cells thus coated with an adhesive layer is shown in FIG. 2.

The extraction layer 3 is then applied onto the adhesive layer 4 and pressed against the substrate such that the entry interfaces of the extractors penetrate into the adhesive layer as shown in FIG. 4, which advantageously allows the distance between the electroluminescent cells and the extractor entry interfaces to be reduced below 1 μm, thus allowing the extraction efficiency to be improved.

After the adhesive hardens, the display panel according to the invention is then obtained; the entry interfaces 32 of the extractors are optically coupled to the electroluminescent layer, and the exit interfaces 33 are directed towards the outside of the display, as shown in FIG. 4.

It can be seen that, in the display thus obtained, each cell has, on average, 1200 extractors (ratio of the cell area/extractor pitch squared).

Thanks to this high average number of extractors per cell, the alignment constraints during the application of the extraction layer 3 onto the cells 21 are avoided, and a thinner extraction layer is used—here only 3 μm or about 4 μm including the adhesive layer—while still obtaining an excellent extraction performance (see below).

The principle of operation of the extractors is shown in FIG. 5 which illustrates a cross section of a portion of the display panel according to the invention comprising three adjacent extractors 31, whose entry interfaces 32, of side L_{E}, are optically coupled to the same cell 21 via an adhesive layer 4.

In the example shown in the figure, the extractor side walls are curved, as opposed to the example shown in FIG. 3, but the principle of operation is identical in both cases.

For a given ray emerging from the cell 21 and penetrating into one of the extractors 31, several different scenarios are possible:
case of ray R₁: it passes directly through the extractor 31, without any intermediate reflection or refraction, as far as the exit interface 33 where it is refracted towards the outside of the display.
case of ray R₂: it encounters one of the side walls 34 of the extractor 31 at an angle of incidence greater than the critical angle of refraction; it is therefore reflected in the direction of the exit interface 33 where it is refracted towards the outside of the display.
case of ray R₃: it encounters one of the side walls 34 of the extractor 31 at an angle of incidence below the critical angle of refraction; it therefore passes through this transparent wall to an adjacent extractor into which it penetrates following a second refraction, then passes directly through this second extractor, without being reflected or refracted, as far as the exit interface 33 of this second extractor, where it is refracted towards the outside of the display.

There are also rays that do not encounter the extraction layer at the base or the entry interface of an extractor; these rays either present an angle of incidence at this point such that they are not totally reflected by this layer but penetrate into it and then emerge from it by one means or another, in a similar manner to the ray R₃ above, or these rays are more inclined at this point and are then reflected by the extraction layer towards the interior of the display, where they are recycled by reflection at the layer of reflecting aluminium electrodes (cathodes).

Other pathways for the light rays emitted by the cell 21 leading towards the outside of the display are of course possible.

It is noteworthy that the critical angle for total internal reflection between the layer of transparent electrodes (anodes) and the layer of extractors is very large since the difference in index between these layers is, in practice, very small: the majority of the rays emitted by the electroluminescent layer therefore cross this interface. Hence, the recycling rate by reflection at this interface remains relatively low compared to the recycling described above.

Using the specific extraction layer just described (see extractor dimensions above), a gain of 80% in emitted light from the display was obtained by comparison with the same display without extraction layer: thanks to the invention, the light extraction efficiency can exceed 30%, against 19% without extraction layer.

According to a variant of the embodiment just described, the extraction layer serves as an encapsulation layer for sealing the display cells and protecting the electroluminescent layer against oxygen and water vapour; the transparent polymer material used for this layer is thus chosen accordingly in a manner known per se.

Without departing from the scope of the invention, other extractor shapes than that described above may be used, notably polyhedra with rectangular bases (the entry and exit interfaces are rectangular), truncated cones (the entry and exit interfaces are circular) or extractors with curved side walls.

The present invention has been described with reference to an OLED display of the top-emitting type; it will be obvious to those skilled in the art that it may be applied to other types of display panels without departing from the scope of the claims that follow, and in particular to back-emitting displays, in which case the extraction layer is advantageously inserted between the substrate and the electroluminescent layer.

1. Lighting or image display panel comprising a substrate carrying:
an electroluminescent organic layer partitioned into electroluminescent cells and inserted between two electrode layers of which one is transparent and the other opaque, each cell corresponding to a region covering one electrode of each layer,
a layer of light extractors operating by reflection, each extractor being made from transparent material and comprising a light entry interface optically coupled to the electroluminescent layer via the said transparent electrode layer, a light exit interface directed towards the outside of the display panel, and side walls forming reflecting optical interfaces for the light propagating within the extractor and a closed reflecting surface,
where the electroluminescent layer region of each cell is optically coupled to a plurality of extractors, wherein, for each extractor, the surface of said light exit interface is superior to the surface of said light entry interface.

2. Panel according to claim 1, wherein the distance between said organic electroluminescent layer and the entry interfaces of the said extractors is less than or equal to 2 μm.

3. Display panel according to claim 1, wherein the said plurality of extractors associated with the said cell comprises over a hundred extractors.

4. Display panel according to claim 1, wherein the said transparent electrode layer is positioned above the said electroluminescent organic layer on the opposite side from the substrate.

5. Display panel according to claim 4, wherein:
the said display panel comprises an encapsulation layer positioned above the said transparent electrode layer,
the said extraction layer forms part of the said encapsulation layer.

6. Display panel according to claim 4, wherein the layer of extractors is applied directly onto the transparent electrode layer.

7. Display panel according to claim 1, wherein the opaque electrode layer is reflecting.
